(19) United States
(12) Patent Application Publication
(10) Pub. No.: US 2010/0028840 A1
(43) Pub. Date: Feb. 4, 2010

(54) EDUCATIONAL TOOL

(76) Inventor: Haruo Matsushima, Yamatokooriyama-shi (JP)

Correspondence Address: ALFRED A. STADNICKI, 1300 NORTH SEVENTEENTH STREET, SUITE 1800, ARLINGTON, VA, 22209, US

(21) Appl. No.: 12/508,060

(22) Filed: Jul. 23, 2009

(30) Foreign Application Priority Data
Jul. 30, 2008 (JP) 2008-215948
Nov. 4, 2008 (JP) 2008-305468

(51) Int. Cl. G09B 23/20

(52) U.S. Cl. 434/281; 434/300

(57) ABSTRACT

A wave function of quantum mechanics is regarded as a vector potential having a component only in a θ-direction of polar coordinates (r, θ, φ). The result of applying a rotational vector operation to the vector potential is regarded as a magnetic field. The result of applying the rotational vector operation to the magnetic field is regarded as an electric field. A drawing on a plane or a three-dimensional model is configured to express both the magnetic and electric fields or one of the fields. The drawing or the model, as an educational tool, visualizes the figure of an atom, enables educands to have a close feeling toward sciences, and especially quantum mechanics, and enables them to have concrete images of various physical phenomena in the atom. The present invention, therefore, provides an educational tool that prevents educands from going away from sciences due to lack of an adequate educational tool of sciences and raises their interest in quantum mechanics inclined to be biased only toward mathematical research.

### REFERENCE TO RELATED APPLICATION

This application is based on Japanese patent application serial No. 2008-215948, filed in Japan Patent Office on Jul. 30, 2008, and No. 2008-305468, filed in Japan Patent Office on Nov. 4, 2008. The contents of these two applications are hereby incorporated by reference.

### BACKGROUND OF THE INVENTION

1. Field of the Invention

The present invention relates to an educational tool useful for education of sciences, in particular quantum physics.

2. Description of Related Art

It has been warned for a long time that younger people are away from sciences. However, it cannot be said that an effective measure has yet been taken. Although liberal arts handle familiar and approachable subjects, and therefore can easily be approached, sciences have become more and more difficult to understand and approach. Especially, it seems appropriate to say that textbooks on quantum mechanics, which is the most basic one of all sciences, almost describe an advanced mathematics rather than the sciences. The sciences in general, and physics as a typical example thereof, are academics that comprehend and explain how material, fluid and electricity function as concretely as possible. It is because mathematics makes expressions more concise or easier to understand than words and sentences that the sciences use mathematics. Concrete images should be main players, and mathematical expressions should be backseat ones.

For example, the solution of a differential equation is handled in such a manner that terms that diverge to an infinite value are thrown away, only terms that converge with a finite value are left, and among even and odd functions emerging in the solution, only the even functions are left and the odd ones are thrown away if a concrete system to be analyzed is symmetrical. Thus, a concrete image takes priority over the result of mathematical operation. Further, a concrete image makes the theory easy to approach and interesting.

However, in quantum mechanics, we can only see, as such concrete images, spheres showing the distribution of probability density shown for example in FIG. 3.22 of a non-patent document 1, which is captioned with “Boundary surfaces for p-and d-orbitals” and is shown in FIG. 10. If an extended interpretation is allowed for the “concrete image,” we can also see graphs of density distribution in a radial direction described in various textbooks, such as FIG. 61 of a non-patent document 2, which is shown in FIG. 11.

The non-patent document 1 is “Molecular Quantum Mechanics” written by Peter Atkins and Ronald Friedman and published by Oxford University Press. The non-patent document 2 is “Quantum Mechanics II” written by Shin-ichiro Tomonaga and published by Misuzu Shobo (Japan).

However, the three pairs of bisected shallow spheres shown at the top of FIG. 10 look identical in other aspects than their direction, and therefore, hardly provide concrete images of orbitals and waves. Even the five groups of quartered bodies shown at the middle and the bottom of the figure cannot provide information on whether a spin exists or not. What is more, FIG. 11, which is a graph, only provides a further poor image and hardly attracts attention to an inconsistency discussed later.

### BRIEF SUMMARY OF THE INVENTION

It is therefore an object of the present invention to solve the above-mentioned conventional problem, and to provide the distribution of an electromagnetic field of a quantum physical system, such as a hydrogen atom which is the origin of quantum mechanics, to thereby enable an educand to have a concrete image, infer an effect of an applied external magnetic field, and accordingly feel familiar with quantum mechanics, which is the most basic one of the sciences.

One aspect of the present invention is directed to an educational tool. The educational tool according to the aspect of the present invention comprises a drawing or three-dimensional model expressing a magnetic field obtained as a result of a rotational vector operation applied to a vector potential. The rotational vector operation is a well known vector operation that applies a rotational operator “rot” to a vector. The vector potential is here a wave function of quantum mechanics regarded as a vector potential only having a component in a θ-direction in polar coordinates (r, θ, φ).

The magnetic field provided by the educational tool visualizes the figure of an atom, i.e., a constitutional unit of material, generates interest in learning sciences among educands, and enables the educands to easily understand that difference in a wave function results in difference in the distribution of a magnetic field and results in difference in the effects of the application of an external magnetic field.

Thus, the educational tool of the present invention visualizes the figure of an atom constituting material, is useful for a phenomenon analysis, and also can generate interest in learning sciences among educands.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a three-dimensional distribution chart of the magnetic field (magnetic lines of force) of a 1s orbital according to a first embodiment of the present invention;

FIG. 2 is a three-dimensional distribution chart of the magnetic field (magnetic lines of force) of a 2pz orbital according to a second embodiment of the present invention;

FIG. 3 is a cross-sectional view showing the electric field (electric lines of force) of a 1s orbital according to a third embodiment of the present invention;

FIG. 4 is a cross-sectional view showing the magnetic field (magnetic lines of force) of a 1s orbital according to a fourth embodiment of the present invention;

FIG. 5 is a cross-sectional view showing the electric field (electric lines of force) of a 2px orbital according to a fifth embodiment of the present invention;

FIG. 6 is a cross-sectional view showing the magnetic field (magnetic lines of force) of a 2px orbital according to a sixth embodiment of the present invention;

FIG. 7 is a perspective view of a distribution model of the electromagnetic field of a 1s orbital according to a seventh embodiment of the present invention;

FIG. 8 is a perspective view of a distribution model of the electromagnetic field of a 1s orbital according to an eighth embodiment of the present invention;

FIG. 9 is a perspective view of a distribution model of the electromagnetic field of a 2px orbital according to a ninth embodiment of the present invention;

FIG. 10 is a perspective view showing the distribution of probability densities according to a conventional educational tool; and

FIG. 11 is a graph showing the probability density of a 2s orbital according to another conventional educational tool.

### DESCRIPTION OF THE PREFERRED EMBODIMENTS

Hereinafter, preferred embodiments of the present invention will be described with reference to the accompanying drawings. For the simplicity of explanation and understanding, a hydrogen atom will be shown as an example. Therefore, an atomic number Z will be replaced with 1 in wave functions.

### 1. First Embodiment

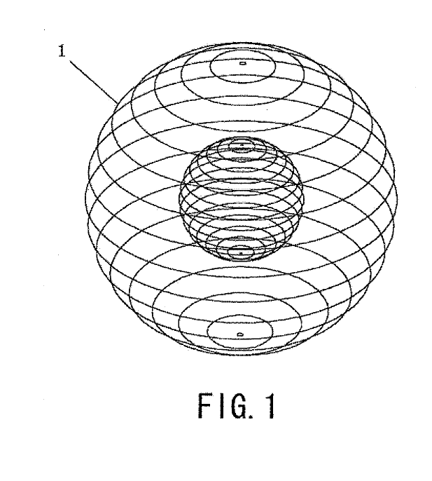

FIG. 1 shows an educational tool according to the first embodiment of the present invention, which shows on a plane the three-dimensional distribution of the magnetic lines of force of the 1s orbital of a hydrogen atom. The 1s orbital, which has the lowest orbital energy among the wave functions of a hydrogen atom, is expressed as follows, using a₀ as the Bohr radius.

(1/π)^{1/2}(1/a₀)^{3/2} exp(−r/a₀)

If this formula is regarded as a vector potential having a component only in a θ-direction of polar coordinates (r, θ, φ), the is orbital can be expressed as follows, using i_{θ} as a unit vector in the θ-direction.

(1/π)^{1/2}(1/a₀)^{3/2} exp(−r/a₀)i_{θ}

Once a rotational operator in a vector space is applied to this formula, a magnetic field expressed as follows can be obtained.

(1/π)^{1/2}(1/a₀)^{3/2} exp(−r/a₀)(1/r−1/a₀)i_{φ}

Here, i_{φ} is a unit vector in a φ-direction.

In polar coordinates, since a set of points having a constant value of radius r constitutes a spherical surface having a radius r, a magnetic line of force formed by a magnetic field having a component only in the φ-direction on the spherical surface (i.e., a curve whose tangential line coincides with the magnetic field in direction at any point of the curve) corresponds to a latitude line of the earth. Although a magnetic field can be calculated for any value of r in principle, FIG. 1 shows the magnetic lines of force 1 (i.e., magnetic field) for two values of r arranged evenly in the θ-direction and thereby expresses a three-dimensional layered structure to avoid complexity.

### 2. Second Embodiment

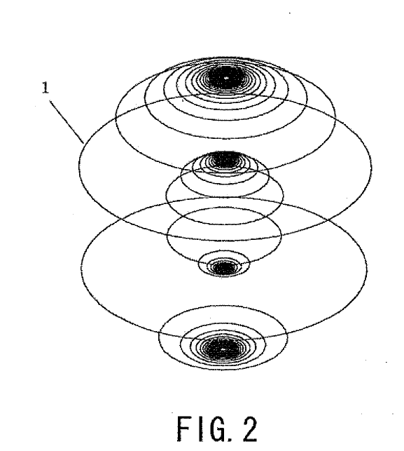

FIG. 2 shows an educational tool according to the second embodiment of the present invention, which shows the magnetic lines of force (i.e., magnetic field) 1 of the 2pz orbital of a hydrogen atom similarly to FIG. 1. The magnetic field is expressed by the following formula.

( 1/32π)^{1/2}(1/a₀)^{3/2} exp(−r/2a₀)(2·r/2a₀)cos θ i_{φ}

Large difference from the 1s orbital shown in FIG. 1 is the presence of cos θ, and thereby, FIG. 2 expresses the unevenness of the magnetic field to some extent by concentrating the magnetic lines of force 1 near the North and South Poles where the magnetic field is strong and by deconcentrating near the equator where the magnetic field is weak.

### 3. Third Embodiment

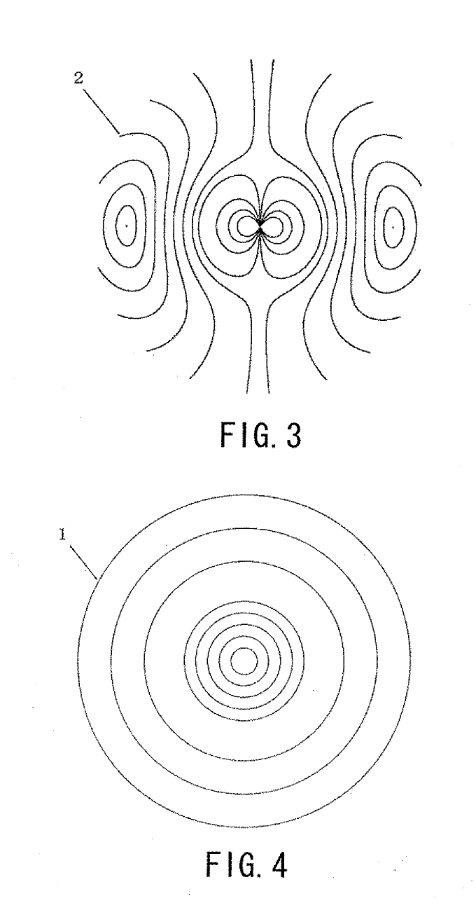

FIG. 3 shows an educational tool according to the third embodiment of the present invention, which shows the electric lines of force (i.e., electric field) 2 of the 1s orbital of a hydrogen atom. By applying a rotational operator to the formula of the magnetic field 1 shown in the explanation of FIG. 1, the following formula can be obtained.

(1/π)^{1/2}(1/a₀)^{3/2} exp(−r/a₀){(1/r²−1/a₀r)cot θ iᵣ+(2/a₀r−1/a₀²)i_{θ}}

Although this formula divided by jωe results in a normal electric field defined by Maxwell's electromagnetic equation, the result is not shown here because of unnecessity for a drawing or model.

Since the iᵣ is a unit vector in an r-direction, the electric field shown by the formula has components both in the θ and r-directions. FIG. 3 was obtained by a process including steps of (1) calculating an electric field at any point on a vertical cross-sectional plane for a certain value of φ by use of a computer from the formula, (2) connecting that point by a segment to another point distant from the former one by a certain infinitesimal distance in a direction of the electric field, (3) calculating the electric field at the latter point, and (4) repeating the steps (2) and (3). The calculation has been performed for the values of the radius r not larger than 2.5 times a₀.

### 4. Fourth Embodiment

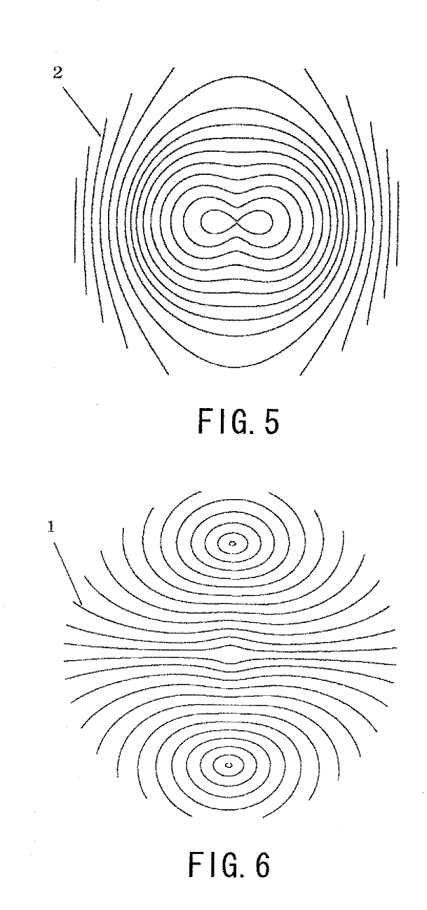

FIG. 4 shows an educational tool according to the fourth embodiment of the present invention, which shows the magnetic lines of force (i.e., magnetic field) 1 of the 1s orbital of a hydrogen atom on a cross-sectional plane at the polar angle θ of 90 degrees, i.e. an equatorial plane. The calculation has been performed for the values of the radius r not larger than 2.5 times a₀ similarly to that for the electric field 2 shown in FIG. 3. FIGS. 3 and 4 are arranged precisely one above the other to show a relation between the electric field 2 and the magnetic field 1.

### 5. Fifth Embodiment

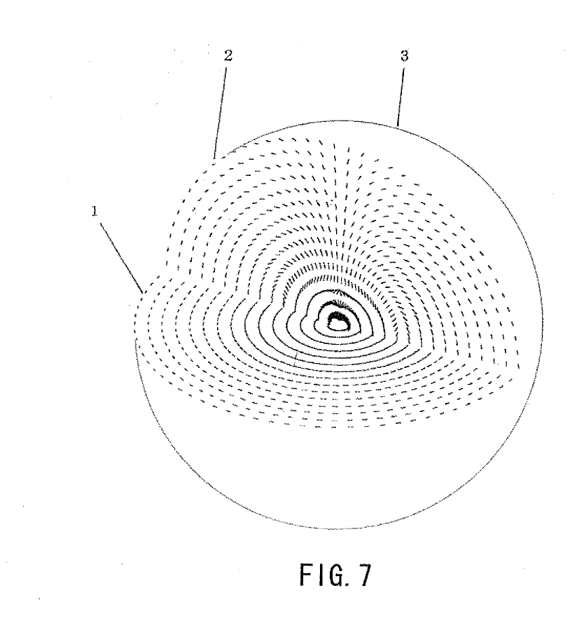

FIG. 5 shows an educational tool according to the fifth embodiment of the present invention, which shows the electric lines of force (i.e., electric field) 2 of the 2px orbital of a hydrogen atom on a vertical cross-sectional plane defined by the azimuthal angles φ of 0 and 180 degrees. By twice applying a rotational operator to the wave function of the 2px orbital regarded as a vector potential having a component only in the θ-direction, the following formula can be obtained.

( 1/32π)^{1/2}(1/a₀)^{3/2} cos φ exp(−r/2a₀){(4/r−1/a₀)cos θ iᵣ+(1/r)/sin θ i_{θ}+(2/a₀−2/r−r/4a₀²)sin θ i_{θ}}

### 6. Sixth Embodiment

FIG. 6 shows an educational tool according to the sixth embodiment of the present invention, which shows the magnetic lines of force (i.e., magnetic field) 1 of the 2px orbital of a hydrogen atom on a horizontal cross-sectional plane at the polar angle θ of 90 degrees. FIGS. 5 and 6 are arranged precisely one above the other similarly to FIGS. 3 and 4, and are shown in a range of radii r not larger than four times a₀ to show a relation between the electric field 2 and the magnetic field 1. The magnetic field 1 shown in FIG. 6 is expressed by the following formula.

( 1/32π)^{1/2}(1/a₀)^{3/2} exp(−r/2a₀){(2−r/2a₀)sin θ cos φ i_{φ}+sin φ iᵣ}

### 7. Seventh Embodiment

FIG. 7 shows an educational tool according to the seventh embodiment of the present invention. This educational tool is a three-dimensional model having a plastic sphere 3 the quarter of which has been cut off. The electric field 2 of the 1s orbital of a hydrogen atom is drawn on the vertical cut surface of the sphere 3, and the magnetic field 1 is drawn on the horizontal cut surface. For both the electric and magnetic fields, the tangential lines of those fields are drawn at a length proportional to the logarithm of the strength of the fields.

### 8. Eighth Embodiment

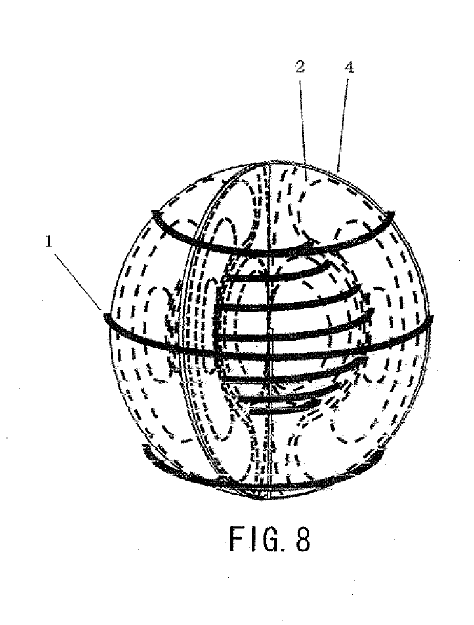

FIG. 8 shows an educational tool according to the eighth embodiment of the present invention. This educational tool is a three-dimensional model having two transparent discs 4 connected with each other at a right angle. The electric field 2 of the 1s orbital of a hydrogen atom is drawn with dashed lines on the two transparent discs 4. Three metal rings expressing the magnetic field 1 of the 1s orbital are contacted and secured to the outer circumferences of the transparent discs 4. The quarters into which each of rings smaller in diameter than the three rings is divided are spherically arranged and secured by adhesion to the vicinity of the center of the electric field discs crossing each other at a right angle, and thereby express the internal magnetic field 1.

### 9. Ninth Embodiment

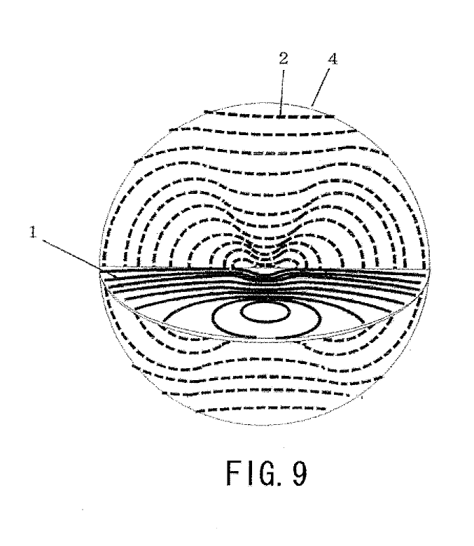

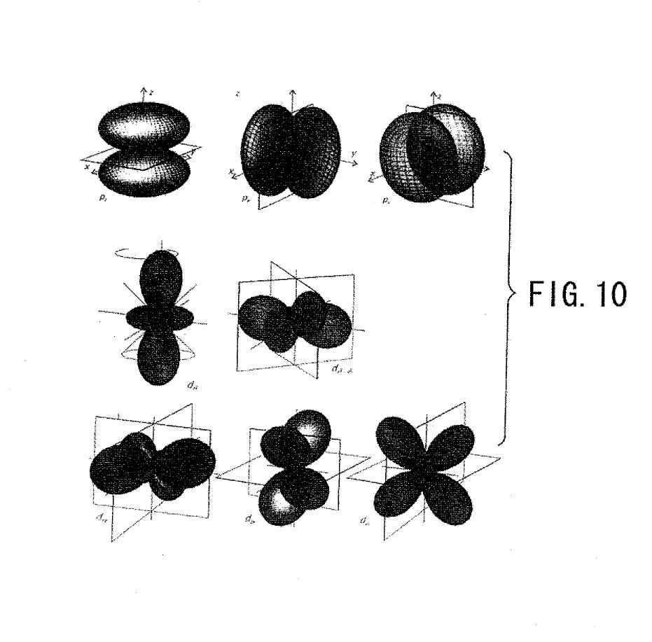

FIG. 9 shows an educational tool according to the ninth embodiment of the present invention. This educational tool is a three-dimensional model having two transparent discs 4 connected with each other at a right angle. The electric lines of force (electric field) 2 of the 2px orbital of a hydrogen atom are drawn with dashed lines on one of the two transparent discs 4 which looks upright in FIG. 9. The magnetic lines of force (magnetic field) 1 are drawn with solid lines on the other one of the two transparent discs 4 which looks horizontal.

Hereinafter, the operation and function of the educational tools configured as stated above will be described. When solving an electromagnetic equation, in general, use of a vector potential can reduce the number of unknown variables, and enables us to solve the equation and calculate the electric and magnetic fields, even if it is hard to directly obtain the solution of the electric and magnetic fields because of the presence of six unknown variables. This method of solving the equation by use of the vector potential is well known among electrical engineers. In the case of a microwave transmission line, such as a waveguide, and a microwave resonator having a transmission line with its inlet and outlet closed, the vector potential is handled as a vector having a component only in a traveling direction.

If a hydrogen atom is compared to a resonator, the traveling wave can be assumed to revolve along a great circle by analogy with an image of an electron revolving around a nucleus. Since only θ is in the direction of the great circle among the polar coordinates (r, θ, φ), the magnetic and thereafter the electric fields were obtained by regarding the wave function as a vector potential having a component only in the θ-direction. However, regarding the wave function as the vector potential might be blamed for blaspheming against quantum mechanics, and therefore, the explanation will hereinafter be given.

A textbook on quantum mechanics says that a wave function represents the existing probability of an electron. FIG. 10 is FIG. 3.22 of the afore-mentioned non-patent document 1, and is explained to show qualitative boundary surfaces. The top three groups of bodies show the existing ranges of an electron on the p orbital, and the middle two and the bottom three groups show those on the d orbital. Each group is formed of plural divided bodies contacting with each other at the origin of the coordinates. Since an electron must revolve around a nucleus, it may be an intuitive question what sort of orbital the electron passes through when moving between the divided bodies. However, the orbital can also be an almost flattened oval. Further, the r-dependent part of the wave function may be proportional to the radius r, and therefore, the wave function is not zero even in the proximity of the origin except for just at the origin where r=0. Therefore, there is no inconsistency or problem.

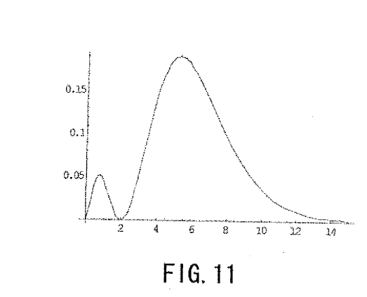

In contrast, FIG. 11 is a graph showing a function obtained by multiplying the wave function of the 2s orbital by the radius r and thereafter calculating the square thereof. The graph also shows an existing probability in a radial direction. Although FIG. 11 may look similar after seeing FIG. 10, the two figures have a large difference from each other. In FIG. 11, the existence probability is zero at r=2a₀. The wave function itself is also zero at the same value of r. Since a set of points where r=(a constant value) form a spherical surface in a polar coordinate system, a simple thinking may lead to an idea that there is no electron movement between the inside and outside of the spherical surface of r=2a₀.

This is still an inconsistency or a problem to be solved. The present invention provides means for solving the problem. Even if it is not an inconsistency, an electron revolves around a nucleus as a wave motion. Therefore, clarifying a profile, an amplitude, and a direction of polarization of the wave motion will be helpful in research and education.

Regarding a hydrogen atom as an electromagnetic resonator will resolve a further large question. It is said that a microwave oven, which is the best known and popular electromagnetic resonator, was invented on the basis of the fact that chocolate was melted in front of a radar transmitter. On the other hand, it is well known among those skilled in the art that a fly keeps flying inside the operating heat chamber of the microwave oven. Its technological expression is that an output load variation coefficient is reduced drastically at a light load. For example, a microwave oven that raises the temperature of 2 liters of water by 10 degrees centigrade by 2 minutes heating is supposed to raise the temperature of 1 liter of water by 20 degrees and 500 milliliters by 40 degrees, because heating for the same length of time is supposed to produce the same amount of heat. However, the temperature increase is reduced with a decrease in a load, and is almost zero at a load of 1 milliliter of water. A fly is a lighter load than the 1 milliliter of water. The fly is, as a matter of fact, exposed to heat from the wall surface of the heat chamber and the like for 2 minutes, and therefore, the temperature is raised to some extent.

In accordance with Japanese Unexamined Patent Publication No. 2004-184031, which discloses the fundamentals of heating in a microwave oven, the heating obeys an equation for a pointing vector. The following formula is the integral expression thereof

$$∮ s ( E \times H ) \cdot nds = \int v ( E \cdot i ) d v + \int v ( E \cdot \partial D / \partial t + H \cdot \partial B / \partial t ) d v$$

If the domain of integration is defined as the whole food to be heated, the left-hand side of the formula, which is the negative whole surface integration of an inner product of a pointing vector (E×H) and a normal vector n on the surface S of the food, expresses an inflow energy, and the right-hand side expresses the behavior of the inflow energy in the volume V inside the surface S. The first term in the right-hand side shows an energy loss, i.e. Joule heat, inside the food, and the second one shows a stored energy. Even though the mechanism of an energy loss exists, no energy flows in and no energy loss is caused without the pointing vector pointing inward.

Radar is a traveling wave, and the pointing vector (E×H) thereof points in the traveling direction. Chocolate placed on the traveling path thereof would be heated by the pointing vector pointing inward. In contrast, inside the resonator, the pointing vector rotates in synchronization with a frequency because of the superposition of the traveling and reflected waves thereof, and therefore, the integration value within one period is zero. In another expression, the traveling and reflected waves of the pointing vector are identical in amplitude and reverse in direction, and therefore, the superposition thereof is zero. Any way, if the left-hand side of the above-described formula is zero, the right-hand side will also be zero, and therefore, there occurs no heating.

Just for reference, when a largish object to be heated, such as food, is placed in a microwave oven, an electric field E causes a displacement current flowing in a dielectric and a conduction current flowing in a conductor in accordance with Ampere's law “rotH=σE+jωεE.” These currents form a magnetic field H. This magnetic field H, together with the electric field E, generates a pointing vector (E×H) which points to the inside of the object, and heats the same.

The foregoing lengthy explanation can be summarized as follows. It can be stated that a traveling wave is in a state where it loses energy, and an electromagnetic wave within a resonator, which is a standing wave, is in a state where it loses no energy, although the two are the same electromagnetic wave.

Quantum mechanics has a basic principle that a particle, such as an electron, has a nature of wave as a photon is related to an electromagnetic wave. It is therefore undoubtedly natural to have a view that a wave motion of a particle has the nature of energy conservation similar to that of the above-stated electromagnetic wave. Therefore, it cannot be thought blasphemous to attribute no photon emission and no energy loss of an electron revolving around a nucleus of a hydrogen atom even with acceleration to the nature of a standing wave in the above-stated resonator.

Without this sort of explanation, an idea that the electron moving with acceleration loses its energy by emitting light and falls to the nucleus moving from one discrete orbital to another is rather close to the common sense of an ordinary person. It is further a question why only an electron being at the lowest energy level on the 1s orbital can remain stable without falling toward the nucleus although an electron on any other orbital than the 1s jumps to another orbital lower in energy level when losing its energy, even if the electron does not emit light due to its accelerated motion. An answer that the wave equation does not allow the idea of an electron falling toward the nucleus would not be physics but mathematics.

Furthermore, the proposed “hydrogen atom resonator theory” can be expected to provide another effect or function. In general, one of magnetic and electric fields varies sinusoidally but the other varies cosinusoidally inside the resonator, and therefore, the total energy of the two fields always maintains a constant value. As a result, if the distribution of one of the two fields is found, the total energy can be calculated. The whole space integration of the square value of the magnetic field of each orbital is partly shown below.

| | |
|---|---|
| 1s orbital | (1/a₀²) |
| 2s orbital | (1/a₀²)/4 |
| 2pz orbital | (1/a₀²)/12 |
| 2px orbital | (1/a₀²)/4.8 |
| 3s orbital | (1/a₀²)/9 |
| 4s orbital | (1/a₀²)/16 |

The energy value of each s orbital is (1/a₀²)/n², where n is a principal quantum number. Multiplying this value by a coefficient (−h²/2mₑ), which frequently appears in quantum mechanics, results in (−h²/2mₑ)/a₀²/n²=−mₑe⁴/(8ε²h²)/n² according to a₀=εh²/(πmₑe²). This expression coincides with an energy level formulated by Bohr.

As the last part of the explanation on the functions or actions, the velocities of both the electromagnetic wave and the electron present inside the resonator will be described. Since an electron cannot move at the velocity of light according to common sense, it can be thought that the electromagnetic wave revolves an integer number of times when the electron makes one revolution, and the two synchronize with each other.

However, since an energy exchange between the electron and the electromagnetic wave remains as a problem, an idea that an electron revolves as a wave motion at the velocity of light inside the hydrogen atom resonator is rather favorable. The central idea of the theory of special relativity is that mass reaches an infinite large value at the velocity of light. Since the definition of inertial mass is the amount of acceleration when an external force is applied, it can be said that the mass does not need to be or cannot be considered under a state where the energy exchange with the exterior is not or cannot be performed. This idea is that an electron comes to have the velocity of light upon transiting into the state of resonance.

Here, description will return to the main subject. The preferred embodiments of the present invention advantageously raise educands' interest in sciences and quantum mechanics with the atomic models or the atomic structure drawings and help to prevent them from going away from sciences, and furthermore, enable them to easily understand the relation of a hydrogen atom with its external magnetic field. Since the distributions of the magnetic fields shown in FIGS. 1 and 2 are in the form of closed circles of magnetic lines of force, the distributions do not respond to the external magnetic field. However, since the distribution of the magnetic field of the 2px orbital shown in FIGS. 6 and 9 is in the form of that of a bar magnet, the distribution can be understood to respond to the external magnetic field as if a compass responds to the earth magnetism.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

As described above, the educational tool in accordance with the present invention visualizes the figure of a quantum physical system, such as a hydrogen atom, enables educands to have a close feeling toward hardly understood or approached sciences and quantum mechanics, prevents them from going away from sciences, enables them to have an image of phenomenon occurring under the application of an external static magnetic field, and is therefore useful for education and research.

What is claimed is:

1. An educational tool, comprising one of a drawing and a three-dimensional model expressing a magnetic field obtained as a result of a rotational vector operation applied to a vector potential, the vector potential being a wave function of quantum mechanics regarded as a vector potential having a component only in a θ-direction of polar coordinates (r, θ, φ).

2. The educational tool according to claim 1, wherein the wave function is a wave function of one of orbitals of a hydrogen atom.

3. The educational tool according to claim 2, wherein the one of orbitals is one of 1s, 2s, 2px, 2py and 2pz orbitals.

4. The educational tool according to claim 2, wherein the educational tool comprises the drawing expressing the magnetic field in a form of magnetic lines of force.

5. The educational tool according to claim 4, wherein the drawing expresses a spatial distribution of the magnetic field as a perspective view.

6. The educational tool according to claim 4, wherein the drawing expresses the magnetic field on a cross-sectional plane defined by 90 degrees of θ.

7. An educational tool, comprising one of a drawing and a three-dimensional model expressing an electric field obtained as a result of a rotational vector operation twice applied to a vector potential, the vector potential being a wave function of quantum mechanics regarded as a vector potential having a component only in a θ-direction of polar coordinates (r, θ, φ)).

8. The educational tool according to claim 7, wherein the wave function is a wave function of one of orbitals of a hydrogen atom.

9. The educational tool according to claim 8, wherein the one of orbitals is one of 1s, 2s, 2px, 2py and 2pz orbitals.

10. The educational tool according to claim 8, wherein the educational tool comprises the drawing expressing the electric field in a form of electric lines of force.

11. The educational tool according to claim 10, wherein the drawing expresses the electric field on a cross-sectional plane defined by a certain value X of φ and X+180 degrees of φ.

12. An educational tool, comprising one of a drawing or a three-dimensional model expressing a magnetic field and an electric field, the magnetic field being obtained as a result of a rotational vector operation applied to a vector potential, the vector potential being a wave function of quantum mechanics regarded as a vector potential having a component only in a θ-direction of polar coordinates (r, θ, φ), the electric field being obtained as a result of a rotational vector operation applied to the magnetic field.

13. The educational tool according to claim 12, wherein the wave function is a wave function of one of orbitals of a hydrogen atom.

14. The educational tool according to claim 13, wherein the one of orbitals is one of 1s, 2s, 2px, 2py and 2pz orbitals.

15. The educational tool according to claim 13, wherein the educational tool comprises the drawing expressing the magnetic field in a form of magnetic lines of force and expressing the electric field in a form of electric lines of force.

16. The educational tool according to claim 15, wherein the drawing expresses the magnetic field on a cross-sectional plane defined by 90 degrees of θ and expresses the electric field on a cross-sectional plane defined by a certain value X of φ and X+180 degrees of φ, and the magnetic field and the electric field are arranged next to each other in a same scale of distance.

17. The educational tool according to claim 13, wherein the educational tool comprises the three-dimensional model having a sphere a quarter of which has been cut off, the electric field is drawn on one cut surface of the sphere defined by a certain value X of φ and X+180 degrees of φ, the magnetic field is drawn on an other cut surface defined by 90 degrees of θ, and for both the electric and magnetic fields, tangential lines of those fields are drawn at a length proportional to a logarithm of a strength of the fields.

18. The educational tool according to claim 13, wherein the educational tool comprises the three-dimensional model having two transparent discs connected with each other at a right angle, one of the discs is defined by a certain value X of φ and X+180 degrees of φ, an other one of the discs is defined by X+90 degrees of φ and X+270 degrees of φ, the electric field is drawn on the two discs in a form of electric lines of force, and the educational tool further comprises a plurality of rings secured to the discs expressing the magnetic field in a form of magnetic lines of force.

19. The educational tool according to claim 18, wherein the number of the rings is plural both in a direction of a radius r and in a direction of a polar angle θ.

20. The educational tool according to claim 13, wherein the educational tool comprises the three-dimensional model having two transparent discs connected with each other at a right angle, a first one of the discs is defined by a certain value X of φ and X+180 degrees of φ, a second one of the discs is defined by 90 degrees of θ, the electric field is drawn on the first disc in a form of electric lines of force, and the magnetic field is drawn on the second disc in a form of magnetic lines of force.
